(19) United States
(12) Patent Application Publication
(10) Pub. No.: US 2025/0085105 A1
(43) Pub. Date: Mar. 13, 2025

(54) A DEVICE FOR DETERMINING ORIENTATION OF AN OBJECT

(71) Applicant: Tilak SRINIVASAN, Bangalore, Karnataka (IN)

(72) Inventor: Tilak SRINIVASAN, Bangalore, Karnataka (IN)

(21) Appl. No.: 18/723,586

(22) PCT Filed: Jan. 11, 2023
(86) PCT No.: PCT/IB2023/050241

§ 371 Date: Jun. 24, 2024

(30) Foreign Application Priority Data
Jan. 11, 2022 (IN) 202241001382

(51) Int. Cl. G01C 9/36; G01C 9/06; G06T 7/70

(52) U.S. Cl. CPC G01C 9/36; G01C 9/06; G06T 7/70; G01C 2009/066

(57) ABSTRACT

The present disclosure discloses a device (100) for determining orientation of an object (200). The device (100) comprises an enclosure (101). A plurality of light sources and a plurality of projection members are positioned around the enclosure (101). Further, the device (100) comprises a light source fixed about the enclosure (101), and an obstacle (103) provided within the enclosure (101). The obstacle (103) is configured to displace within the enclosure (101), pointing towards an uppermost position due to buoyant force of the fluid (106), and thus blocks impingement of light on to corresponding one or more projection members (102). The portions of the plurality of projection members (102) on which a shadow is cast, is captured by one or more image capturing units (108) to generate corresponding images, which is received by a computing unit (107) to determine orientation of the object.

### TECHNICAL FIELD

Present disclosure relates in general to a device for determining orientation of an object. Particularly, but not exclusively the present disclosure relates to a device for determining the orientation of the object about pitch, roll and yaw axes of the object.

### BACKGROUND OF THE DISCLOSURE

Determining orientation of an object may be useful in numerous applications. One such example is an airborne object such as an airplane or a helicopter, where the orientation of the airborne object is used to aid in determining orientation of the object and as well as aid in navigation of the object from its current location to a desired location. Generally, in order to describe a particular orientation or position of a rigid object in a 3-dimensional medium, three parameters along the X-axis, Y-axis and Z-axis are considered.

Conventionally, Euler angles are used to represent both the position and orientation of the rigid body. A local co-ordinate system having the following axes denoted by x, y and z which constitute the axes of frame and another co-ordinate system X, Y and Z which constitute the axes of the rotated frame. By using these co-ordinates both position and orientation of the rigid body can be determined, wherein, the reference orientation can be imagined to be a first orientation from which the frame virtually rotates to reach its actual orientation.

Myriad of devices such as gyroscopes, gimbal etc., are used in moving vehicles and aircrafts to determine the pitch, roll and yaw axes which play a key role in determining the orientation and positioning the moving vehicle/aircraft. A gyroscope works on the principle of angular momentum which basically is the amount of rotation an object has, taking into account its mass and shape. In simple words it is the vector quantity that represents the product of a body's rotational inertia and rotational velocity about a particular axis. However, the gyroscopes and gimbals may include multiple moving parts, which require frequent calibration for exhibiting accurate values. Also, the existing systems or arrangements may include more number of parts, which makes the system bulky and involves complex operational features.

Conventionally available orientation detection devices may include light sources and sensors which are, generally, positioned within a transparent enclosure of such devices. However, servicing and maintenance of such devices may tedious and cumbersome, as repairs of the light sources and the sensors may require complete disassembly of the transparent enclosure of the device. Also, for performing such disassembly and re-assembling of the device, a skilled operator may be required, thereby increasing costs associated with maintenance and servicing.

The present disclosure is directed to overcome one or more limitations stated above or any other limitation associated with the prior arts.

### SUMMARY

The shortcomings of the prior art are overcome and additional advantages are provided through the provision of a device as disclosed in the present disclosure.

Additional features and advantages are realized through the techniques of the present disclosure. Other embodiments and aspects of the disclosure are described in detail herein and are considered a part of the disclosure.

In a non-limiting embodiment of the present disclosure, a device for indicating orientation of an object is disclosed. The device comprising a housing which is mountable on the object. The housing comprises a first light source disposed on a first face of the housing and a second light source disposed on a second face of the housing. The device also includes a first screen disposed on a third face of the housing, opposite to the first light source, and a second screen disposed on a fourth face of the housing opposite to the second light source. The device further includes an enclosure disposed within the housing, where the enclosure filled with a fluid. Further, the device includes an obstacle which is disposable within the enclosure. The obstacle is adapted to occupy an uppermost point within the enclosure. The obstacle is adapted to cast a shadow on the first screen and the second screen based on light illuminated from the first light source and the second light source, to indicate orientation of the object.

In an embodiment, the obstacle displacing within the enclosure aligned and occupied at the uppermost point of the enclosure, is configured to blocks the impinging light to cast the shadow on a corresponding portion of the first screen and the second screen.

In an embodiment, the enclosure is made of a transparent material to allow impinging light from the first light source and the second light source be projected on to the first screen and the second screen.

In an embodiment, the obstacle is made of an opaque material to block impinging light to cast the shadow on a portion of each of the first screen and the second screen.

In an embodiment, the device is configured to determine the orientation of the object in pitch, yaw and roll axes.

In an embodiment, the enclosure is defined with a spherical shape.

In an embodiment, the device comprising one or more image capturing units, configured to capture images of the shadow casted on the first screen and the second screen. The device further comprising a computing unit which is communicatively coupled to the one or more image capturing units. The computing unit is configured to receive the images captured by the one or more image capturing units. The computing unit is then configured to determine position of the casted shadow on the first screen and the second screen. The computing unit also configured to indicate position of the obstacle, based on determined positions of the shadow on the first screen and the second screen.

In an operational embodiment, when the object changes its orientation, the device positioned on the object changes orientation, then position of the obstacle in the hollow spherical member changes. That is, the obstacle displaces within the hollow spherical member in a direction corresponding to the direction of change in orientation of the object. The obstacle displaces (i.e., revolves) by always occupying the highest position of the hollow spherical member due to buoyant force exerted by the fluid in the hollow spherical member. This leads to blocking of light by the obstacle, thereby casting the shadow on a portion of the plurality of projection members. In other words, based on position and/or location of the obstacle, impingement of light passing through the hollow spherical member may be blocked, thereby casting shadow at different locations on the plurality of projection members. The one or more image capturing units captures images of the plurality of projection screens and based on position of the casted shadow in the captured images, the computational unit determines orientation of the object about pitch, roll and yaw axes in analog and/or digital form.

### BRIEF DESCRIPTION OF THE ACCOMPANYING DRAWINGS

The novel features and characteristic of the disclosure are set forth in the detailed disclosure. The disclosure itself, however, as well as a preferred mode of use, further objectives and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 illustrates sectional view of a device for indicating orientation of the object, in accordance with an exemplary embodiment of the present disclosure.

FIG. 2 illustrates the device of FIG. 1 being positioned on an object, which is in an idle condition in accordance with an exemplary embodiment of the present disclosure.

FIG. 3 illustrates device of FIG. 1, positioned on the object, which is oriented at an angle α with respect to horizontal, in accordance with an embodiment of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION OF THE DISCLOSURE

The foregoing has broadly outlined the features and technical advantages of the present disclosure in order that the description of the disclosure that follows may be better understood. Additional features and advantages of the disclosure will be described hereinafter which form the subject of the disclosure. It should be appreciated by those skilled in the art that the conception and specific embodiment disclosed may be readily utilized as a basis for modifying or designing other devices for carrying out the same purposes of the present disclosure. It should also be realized by those skilled in the art that such equivalent constructions do not depart from the spirit and scope of the disclosure. The novel features which are believed to be characteristic of the disclosure, as to its organization, together with further objects and advantages will be better understood from the following description when considered in connection with the accompanying figures. It is to be expressly understood, however, that each of the figures is provided for the purpose of illustration and description only and is not intended as a definition of the limits of the present disclosure.

Referring now to the drawings wherein the drawings are for the purpose of illustrating an exemplary embodiment of the disclosure only, and not for the purpose of limiting the same.

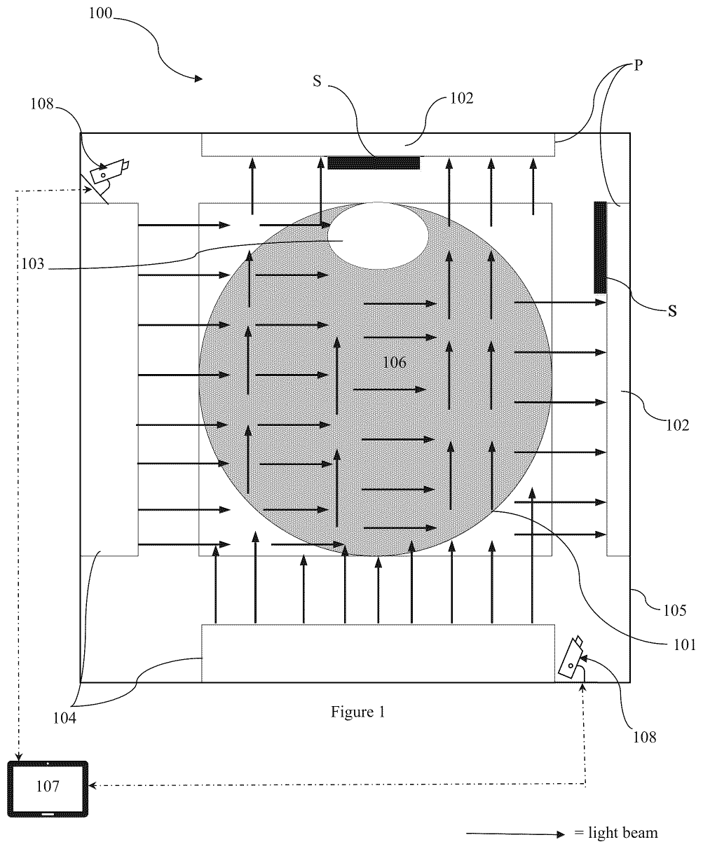

FIG. 1, illustrates a front view of a device (100) for determining orientation of an object (200). The device (100) may include an enclosure (101). The enclosure (101) is depicted to resemble a hollow spherical member as seen in each of FIGS. 1-3. The enclosure (101) may be positioned within a housing (105) such that, the enclosure (101) may be supported by the housing (105). In an embodiment, the enclosure (101) may be made of transparent material, which allow light to pass through. In an embodiment, the enclosure (101) may be made from material including, but not limited to, glass, transparent polymer, silica and the like. The enclosure (101) may be rigidly positioned within the housing (105) by means of trusses, links, strings, or connectors, which have not been indicated in the figures for simplicity of explanation. Also, such trusses, strings, links or connectors, may be made of substantially transparent material or be structured with dimension negligible, in order to minimize interference of such means with working of the device (100), the enclosure (101) or that of the object (200). Additionally, the enclosure (101) may be substantially positioned at center of the housing (105) or may be suspended relative to walls of the housing (105) for operation of the device (100).

Further, the device (100) may include a one or more light sources (104), which may be positioned within the housing (105) and may be positioned on one or more faces of the housing (105) at a distance from the enclosure (101), In an embodiment, each of the one or more light sources (104) may be coupled to the housing (105) or may be positioned inside one or more cutouts [not shown in figures explicitly] defined in the housing (105) such that, illumination portion of the one or more light sources (104) may be positioned in vicinity of the enclosure (101). That is, the one or more light sources (104) may be positioned either of left and bottom, left and top, right and top, right and bottom, and any combination thereof of faces of the housing (105). Furthermore, the device (100) may include a plurality of projection members (102) [or interchangeably referred as “plurality of screens”], which may be positioned opposite to each of the one or more light sources (104). Each of the plurality of projection members (102) may be configured to display light emitted by the plurality of light emitting sources.

In an embodiment, the projection member may be but not limiting to screen, sheet and the like, capable of displaying the light emitted by the light sources (104).

Referring further to FIG. 1, the device (100) may include an obstacle (103) which may be provided within the enclosure (101). The obstacle (103) may be configured to displace i.e., roll and/or revolve freely within the enclosure (101) relative to orientation or displacement of the object (200). The enclosure (101) may be filled with a fluid (106). As an example, the fluid (106) may be air, gas, water, oil and any other fluid (106) which serves the same purpose, while the obstacle (103) may be an air-tight member, having density lesser than the density of the fluid (106). In an embodiment, the obstacle (103) may be buoyant in the fluid (106) displaces within the enclosure (101) pointing towards upper most position, i.e., the obstacle (103) occupies substantially upper most position of the enclosure (101) irrespective of position of the housing (105). In other words, due buoyancy effect, the obstacle (103) may occupy the uppermost point of the inner surface (110) of the enclosure (101). In an embodiment, the uppermost position of the enclosure (101) may continuously vary based on the orientation of the object, where subsequent uppermost position of the enclosure (101) may at position in which buoyant forces of the fluid (106) is at a maximum value. The obstacle (103) may roll and/or revolve within the enclosure (101) and may occupy an uppermost position within the enclosure (101) at that instant of time during orientation of the object. In an embodiment, the obstacle (103) occupying the uppermost position may block impingement of light from each of the one or more light sources (104), thereby casting a shadow on each of the plurality of projection members (102).

Further, as apparent from FIG. 1, the device (100) may include one or more image capturing units (108), which may be configured to capture images on each of the plurality of projection members (102). The images captured by the one or more image capturing units (108) may be received by a computing unit (107), where the one or more image capturing units (108) are communicatively coupled to the computing unit (107). In an embodiment, analyzing by the computing unit (107) may include determining position of the casted shadow on each of the images and determine orientation of the object (200). The computing unit (107), may be programmed to indicate orientation of the object (200) in pitch, roll and yaw axes, based on position of the casted shadow on each of the plurality of projection members (102) in at least one of an analog form and a digital form.

In an embodiment, the obstacle (103) may be made of an opaque material, to completely or at least substantially block impingement of light on to the plurality of projection members (102), for effective functioning of the device (100).

In an embodiment, the computing unit (107) may be associated with an indication unit such as a display to indicate orientation with respect to pitch, yaw and roll axes of the object. The indication unit (108) indicates orientation of the object in at least one of analog form or digital form.

In an embodiment, the housing (105) may facilitate in fastening or positioning the device (100) on an object, whose orientation has to be determined. As an example, the housing (105) may assist in fastening the device (100) on to the object via fastening means, such as but not limiting to screw fastening, bolting arrangement and the like.

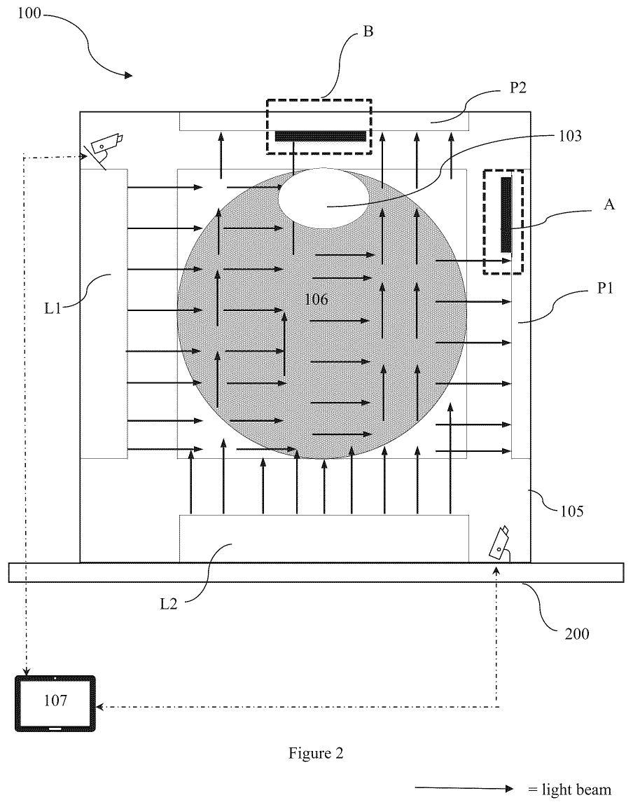

Now referring to FIG. 2 which, illustrates the device (100) fixed to an object/platform (200). The object/platform (200) is in an idle condition i.e., orientation or displacement of the object/platform (200) is zero. In an illustrated embodiment, the device (100) is described in relation to the one or more light sources (104) including a first light source L1, and a second light source L2, and the one or more projection members including a first screen P1 and a second screen P2. However, the same cannot be construed as a limitation, since the device (100) may include a one or more light sources (104) and projection members (102). In an embodiment, the number of light sources (104) and the projection members (102) may be dependent on configuration of the housing (105) accommodating the enclosure (101). The obstacle (103) may displace within the enclosure (101), pointing and/or aligning towards uppermost position of the enclosure (101), that may correspond to position of the enclosure (101) having highest buoyant force by the fluid (106) contained therein. The obstacle (103) in the uppermost position, may block impingement of at least one of the first light source L1 and the second light source L2 to cast a shadow on to a portion of at least one of the first screen P1 and the second screen P2, respectively. In the illustrative embodiment, the obstacle (103) may resemble a capsule like structure, which may be buoyant in the fluid (106) and, that may obstruct light from each of the first light source L1 and the second light source L2 thereby casting shadow at portion A on P1 and at portion B on P2. In an embodiment, the uppermost position of the enclosure (101) may continuously vary based on variation in orientation of the object (200). Further, the one or more image capturing units (108) may continuously capture the images on the first screen P1 and the second screen P2, where the captured images may be fed into the computing unit (107). Based on position of the casted shadow in the images captured by the one or more image capturing units (108), the computing unit (107) may indicate orientation of the object (200), in pitch, roll and yaw axes (i.e., three mutually perpendicular axes), in digital or analog from.

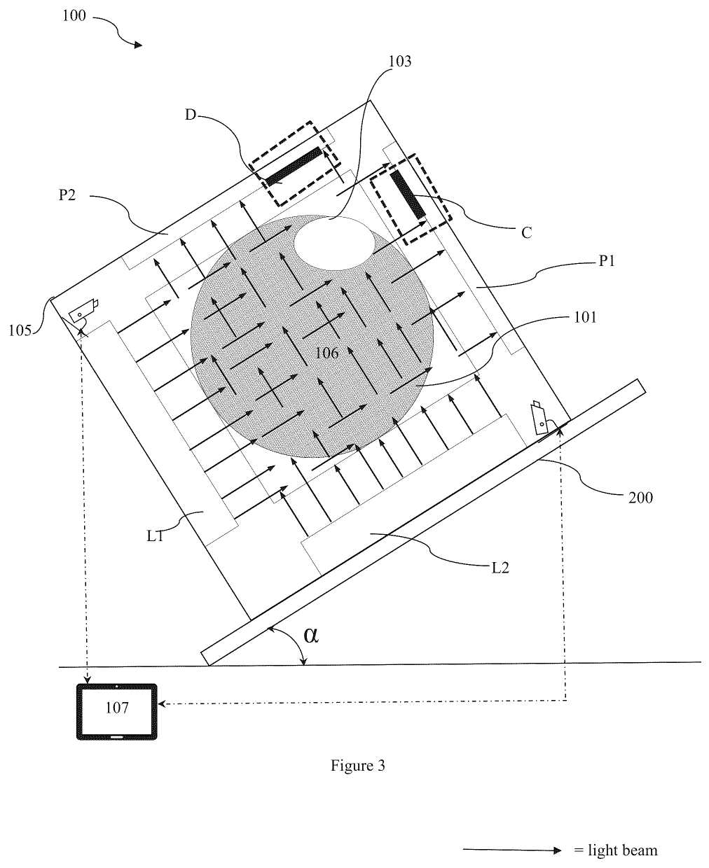

Now referring to FIG. 3, which illustrates the device (100) positioned on the object (200). In an illustrative embodiment, the object (200) is oriented at a certain angle α with respect to horizontal plane such as ground. Upon orientation of the object (200), the obstacle (103) may displace or roll, within the enclosure (101), aligning at the uppermost position of the enclosure (101), based on orientation of the enclosure (101) (thus, the object (200)). The obstacle (103) in the uppermost position, may block impingement of light from each of the first light source L1 and the second light source L2 on to a portion of the first screen P1 and the second screen P2, respectively thereby casting shadow at portion C on the first screen P1 and at portion D on the second screen P2. In an embodiment, the uppermost position of the enclosure (101) may continuously vary based on the orientation of the object (200). Further, the one or more image capturing units (108) may continuously capture the images of the projection members (102) P1 and P2, where the captured images may be transmitted to the computing unit (107). In an embodiment, the computing unit (107) may be at least one of a computer, a laptop, a mobile phone, a microprocessor, a microcomputer and any other device capable of receiving the images and analyzing orientation of the object (200). Based on position of the casted shadow in the images captured by the one or more image capturing units (108), the computing unit (107) may indicate orientation of the object (200), in pitch, roll and yaw axes (i.e., three mutually perpendicular axes), in digital or analog from.

In an embodiment, the computing unit (107) may be configured to determine corresponding positioning of the shadow along X-direction, Y-direction and Z-direction in order to compute and determine inclination relative to the horizontal plane, such as ground. Further, in case orientation of the object (200) tends to be normal to the horizontal plane (i.e., at 90 deg), then area of shadow being cast by the obstacle (103) on the first screen S1 and the second screen S2 may be analyzed by the computing unit (107). For instance, in case orientation of the object (200) may be normal, i.e., angle α of FIG. 3 is 90 deg inclined towards left (in direction of angle α), then due to profile of the obstacle (103) resembling a capsule like structure, area of shadow being cast on the first screen P1 would be less than the area of shadow being cast on the second screen P2, while position of shadow on the first screen is substantially central and position of shadow on the second screen P2 is substantially at an end or edge. With such variation in position and/or area of the shadow, the computing unit (107) may be configured to determine and indicate orientation of the device (100) and in-turn that of the object (200).

In an embodiment, the uppermost position of the enclosure (101) may change continuously based on orientation of the object. Thus, the obstacle (103), blocks light from the one or more light sources (104) at the uppermost position of the enclosure (101) at that instant of time, and thus facilitates in determining orientation of object.

In an embodiment, the device (100) facilitates in determining orientation of the object about three mutually perpendicular axes i.e., Pitch, Roll and Yaw axes in that position.

In an embodiment, the object (200) may be at least one of automobiles, aircrafts, ships, position sensing units for manufacturing machines and the like.

In an embodiment, the one or more light sources (104) may be at least a laser beam, candescent light source, and an incandescent light source, which may impinge light onto each of the plurality of projection members (102).

In an embodiment, the enclosure (101) may be coupled to the housing (105) by a support element (not shown in Figures), which may have minimal or negligible impact on passing of light transmitted by the one or more light sources (104). The support element may be transparent and may be include structure such as but not limited to, a rod, a shaft, a beam and any other structure capable of holding the enclosure within the housing (105).

In an embodiment, the obstacle (103) is a hollow member which may be made of opaque material. Alternatively, the obstacle (103) may be coated by suitable coating material to render the obstacle (103) optically opaque.

In an embodiment, the housing (105), the enclosure (101), and/or the obstacle (103) may be made from additive manufacturing method, such as, three-dimension (3D) printing technique.

In an embodiment, the device (100), is simple in construction.

In an embodiment, the housing (105) of the device (100) including the one or more light sources (104), the plurality of projection members (102) and the enclosure (101) may be maintained in vacuum.

In an embodiment, due to simple construction, the device (100) is economical for manufacture.

In an embodiment of the present disclosure, the orientation determination of a particular object can be determined by the device (100) provisioned with at least one or combination of the following but not limiting to analog markings, use of sensors or any other similar orientation measuring techniques which are known in the art.

### EQUIVALENTS

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

While various aspects and embodiments have been disclosed herein, other aspects and embodiments will be apparent to those skilled in the art. The various aspects and embodiments disclosed herein are for purposes of illustration and are not intended to be limiting.

REFERRAL NUMERALS

| Description | Referral Numeral |
|---|---|
| Device | 100 |
| Enclosure | 101 |
| Projection members | 102 |
| Obstacle | 103 |
| Light sources | 104 |
| Housing | 105 |
| Fluid | 106 |
| Computing unit | 107 |
| Image capturing unit | 108 |
| Object or Platform | 200 |

1. A device (100) for indicating orientation of an object (200), the device (100) comprising:
a housing (105) mountable on the object (200), the housing (105) comprises:
a first light source (L1) disposed on a first face of the housing (105);
a second light source (L2) disposed on a second face of the housing (105);
a first screen (P1) disposed on a third face of the housing (105), opposite to the first light source (L1); and
a second screen (P2) disposed on a fourth face of the housing (105) opposite to the second light source (L2);
an enclosure (101) disposed within the housing (105), the enclosure (101) filled with a fluid (106); and
an obstacle (103) disposable within the enclosure (105), the obstacle (103) is adapted to occupy an uppermost point within the enclosure (105),
wherein the obstacle (103) is adapted cast a shadow (15) on the first screen (P1) and the second screen (P2) based on light illuminated from the first light source and the second light source, to indicate orientation of the object (200).

2. The device (100) as claimed in claim 1, wherein the obstacle (103) displacing within the enclosure (101) aligned and occupied at the uppermost point of the enclosure (101), is configured to blocks the impinging light to cast the shadow on a corresponding portion of the first screen (P1) and the second screen (P2).

3. The device (100) as claimed in claim 1, wherein the enclosure (101) is made of a transparent material to allow impinging light from the first light source (L1) and the second light source (L2) be projected on to the first screen (P1) and the second screen (P2).

4. The device (100) as claimed in claim 1, wherein the obstacle (103) is made of an opaque material to block impinging light to cast the shadow on a portion of each of the first screen (P1) and the second screen (P2).

5. The device (100) as claimed in claim 1, wherein the device (100) is configured to determine the orientation of the object (200) in pitch, yaw and roll axes.

6. The device (100) as claimed in claim 1, wherein the enclosure (101) is defined with a spherical shape.

7. The device (100) as claimed in claim 1, comprising one or more image capturing units (108), configured to capture images of the shadow casted on the first screen (P1) and the second screen (P2).

8. The device as claimed in claim 7, comprising a computing unit (106) communicatively coupled to the one or more image capturing units (107), the computing unit (106) is configured to:
receive the images captured by the one or more image capturing units (108),
determine position of the casted shadow on the first screen (P1) and the second screen (P2), and
indicate position of the obstacle (103), based on determined positions of the shadow on the first screen (P1) and the second screen (P2).
